(19) United States
(12) Patent Application Publication
(10) Pub. No.: US 2008/0189971 A1
(43) Pub. Date: Aug. 14, 2008

(54) Electronic disc and drum brake gauge

(76) Inventor: Lin Wo, Suzhou New District (CN)

Correspondence Address: DONN K. HARMS;PATENT & TRADEMARK LAW CENTER, SUITE 100, 12702 VIA CORTINA, DEL MAR, CA, 92014, US

(21) Appl. No.: 12/069,957

(22) Filed: Feb. 13, 2008

Related U.S. Application Data
(60) Provisional application No. 60/901,526, filed on Feb. 14, 2007.

(51) Int. Cl. G01B 5/08

(52) U.S. Cl. 33/784

(57) ABSTRACT

A brake disc and drum measuring device featuring an elongated member attached to two pairs of jaws extending in opposite directions from the member. A first of said first pair of jaws engaged to said member is adapted to measure a brake rotor while as second pair of jaws measures brake drums. A digital display is always in view with digital indicia right-side-up when the device is being employed in the as-used position with the first pair of jaws extending upward relative to the user's face. Large shoulders on a second pair of jaws provide for easy positioning on brake drums having oversized extensions from their sidewall. A moveably jaw on the second pair also allows the device to be balanced.

This application claims priority from U.S. Provisional Patent Application Ser. No. 60/901,526 filed Feb. 14, 2007, and incorporated in its entirety by reference herein.

### FIELD OF THE INVENTION

The disclosed system and method relates to the taking of accurate mechanical measurements for machining purposes. More particularly, it relates to a device providing electronic measurements of both disc brake calipers and conventional drum brake drums in a single and highly accurate measuring instrument.

### BACKGROUND OF THE INVENTION

Automobiles, trucks, airplanes, and other vehicles which roll on wheels across a road or surface are equipped with brakes to slow the vehicle and also to stop it from rolling. Such wheeled brake systems exist primarily in two types which include disc and drum braking systems.

The typical conventional brake system consists of disc brakes on the front wheels and either disc or drum brakes on the rear wheels connected by a system of tubes and hoses that link the brake at each wheel to the master cylinder. Other systems that are connected with the brake system include the parking brakes, the power brake booster and the anti-lock system.

Employing a brake hydraulic system, stepping on the brake pedal forces hydraulic oil (brake fluid) through a series of tubes and hoses to the braking unit at each wheel. Since fluid cannot be compressed, pushing fluid through the conduit is just like pushing a steel bar through a pipe and the many twists and turns on its way to its destination. Once reaching the wheel, the fluid imparts the exact same motion and pressure to a caliper or lave cylinder.

In a disc brake type system, the fluid from the master cylinder is forced into a caliper where it presses against a piston. The piston, in-turn, squeezes two brake pads against opposing contact surfaces on a planar rotor which is attached to the wheel, forcing it to slow down or stop.

In a drum brake system, the fluid is forced into the wheel slave cylinder which pushes the brake shoes out so that the friction linings press against a contact surface on the drum which is attached to the wheel, causing the wheel to stop.

In either case, the friction surfaces of the pads on a disc brake system, or the shoes on a drum brake convert the forward motion of the vehicle into heat. Heat is what causes the friction surfaces (linings) of the pads and shoes to eventually wear out and require replacement. Consequently, in both types of systems there is an eventual need of repair since over time the friction of the shoes and pads on the contact surfaces of the drum and rotors respectively will cause the contact surface to wear and will impair full contact of the discs and shoes with their contact surfaces. Incomplete contact, of course, causes the braking system to become dysfunctional or less efficient.

Consequently, in both types of systems, the contact surfaces upon which the shoes engage the drum, or the pads engage the rotor, must be occasionally resurfaced to insure complete contact of the frictional pads and shoes with the surface they contact.

Since resurfacing involves removing metal material from the structure of the rotor or the drum, it is imperative that good measurements are taken of the surface to be machined, to insure that only the amount necessary is removed from the structures. Also imperative is ascertaining that the final structure, after the removal of metal, is of sufficient thickness to be operated safely. This is because over turning of the rotor or drum to smooth the contact surface can cause too much material to be removed, rendering the drum or disc unsafe to use.

Commonly employed in the measurement of metal surfaces being subjected to machining is a caliper which the user engages against the side contact surface to be resurfaced and the opposite side to ascertain a thickness of the part. Some are adapted to measure both discs and drums. However, such devices are configured to require the user to hold the very heavy drum in the air while measuring it, or to employ display gauges which cannot be read right-side up or easily while holding the caliper in contact with the drum.

Accordingly, there is an unmet need for a measuring device which will accurately measure both disc brake rotors and drum brake contact surfaces and which will provide accurate measurements of either type of surface using a single measuring instrument engaged to an electronic meter and display. Such a device should position the digital display of the distance being measured in easy view of the user. Further, such a device should provide a means to support the device on a heavy brake drum and easily take and read the measurement of the diameter of the drum.

In this respect, before explaining at least one embodiment of the invention in detail, it is to be understood that the invention is not limited in its application to the details of construction and to the arrangement of the components set forth in the following description or illustrated in the drawings nor the steps outlined in the specification. The invention is capable of other embodiments and of being practiced and carried out in various ways as those skilled in the art will readily ascertain from reading this application. Also, it is to be understood that the phraseology and terminology employed herein are for the purpose of description and should not be regarded as limiting.

As such, those skilled in the art will appreciate that the conception upon which this disclosure is based may readily be utilized as a basis for designing other methods and systems for carrying out the several purposes of the present invention of a brake disc and drum measuring instrument. It is important, therefore, that the claims be regarded as including such equivalent construction insofar as they do not depart from the spirit and scope of the present invention.

### OBJECTS OF THE INVENTION

An object of this invention is the provision of a combination disc and drum brake measuring device.

An additional object of this invention is the provision of such a measuring device that has surfaces allowing it to rest upon heavy brake drums while concurrently providing accurate diameter measurements of the drum.

Yet another object of this invention is to provide such a device which is configured to allow the user to easily see the digital display during use without straining or going into awkward positions.

It is thus an object of the invention to provide a device for measuring both disc brake rotors and drum brake drums which allows for easy reading of the electronic display during use for either measurement and a support on the drum to insure equal depth of both measuring points. These together with other objects and advantages which will become subsequently apparent reside in the details of the construction and method as more fully hereinafter described and claimed, reference being had to the accompanying drawings forming a part thereof, wherein like numerals refer to like parts throughout.

### SUMMARY OF THE INVENTION

The disclosed device provides for accurate measurements of both disc brake rotors and drum brake drums in a single instrument that is easy to employ by a user. Conventional electronic disc & drum brake calipers are available from various sources. However, such devices conventionally employ opposing outside measuring jaws for measuring the thickness of the discs which are designed to point downward towards the feet of the person reading the measurement from LCD display when in the as-used position in the hands of the user while measuring a disc. Such conventional devices may also employ a set of inside measuring jaws which are employed to measure the inside diameter of a brake drum. Conventionally, these inside measuring jaws point upward or away from the person or their feet, when the device is in the as-used position in the user's hand reading the LCD display.

Configuring the display read out and opposing jaws in this fashion makes it very difficult, in both cases, for the user to actually read the LCD display, while concurrently trying to hold the heavy parts and trying to bias the jaws being used toward the surfaces being measured to take the measurement.

The device disclosed and described herein, employs the outside measuring jaws (for disc thickness measurement) which in the as-used position, points upward and away from the feet or chest of the user depending on the placement of the disc being measured. The disclosed device also provides translatable inside measuring jaws (for measuring the drum diameter measurement), both of which point downward toward the feet or body of the user when in the as-used position. An electronic gauge, operatively engaged to the jaws, has an electronic or LCD display to depict the numerals relative to the measurement being taken and it may be read directly in front of the user while the device is in the as-used position taking either type of measurement with the device.

Additionally provided for further utility and ease of use are wide shoulder portions on each side of the inside measurement jaws (for drum diameter measurements). These shoulder portions have a flat surface substantially parallel to the axis of the elongated member engaging the two sets of jaws. A generally “L” shaped second member extends from each of the shoulder portions. It has been found that the shoulder portions work best if sized at least twice the length of the distal portion of the second member which also extends parallel to the axis of the elongated member to a pointed tip employed for measurements. The long shoulders provide a surface for the user to support the device upon the opposing edges of a brake drum being measured, no matter what the configuration of the edge of the drum. It also allows for the drum to be supported on a table or the floor while the device is employed in the as-used position.

Also provided are gaps between the distal end and shoulder portion of the jaws. The gaps have an inner sidewall that angles away from the tip of the distal end to allow for engagement of the device around odd shaped brake drums while still supporting the device on the two opposing edges.

### BRIEF DESCRIPTION OF DRAWINGS

FIG. 1 is a depiction of the disclosed device showing the opposing pairs of members adapted for measurements of brake drums and discs during concurrent viewing of the gauge.

FIG. 2 depicts the device in the as-used position on a brake drum supported on a floor or other surface showing the wide shoulders supporting the device and display positioned for easy reading.

### DETAILED DESCRIPTION OF THE PREFERRED EMBODIMENT

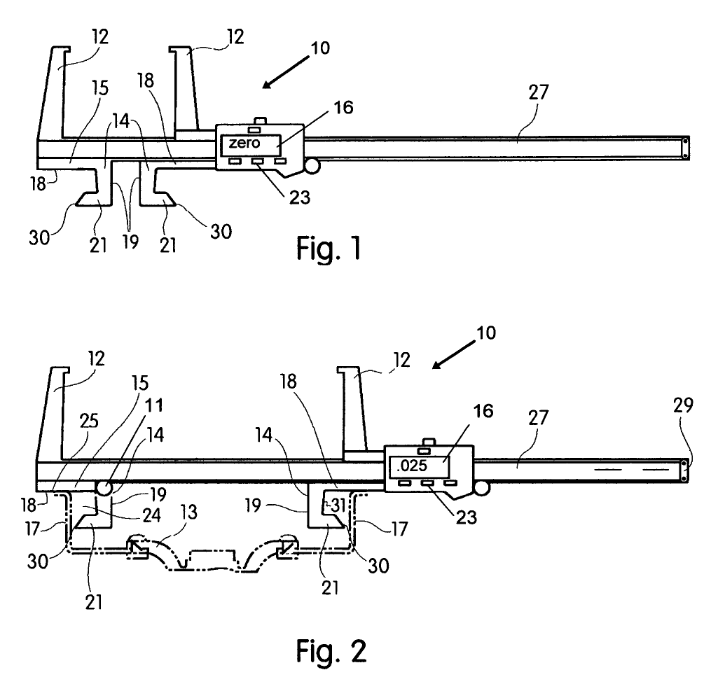

The brake disc and drum micrometer device 10 as shown in FIG. 1, employs the exterior measuring jaws 12 for measurements of opposing rotor sidewalls of a disc brake rotor, which when properly extended point upward away from the user's feet or chest when the device 10 is in the hands of the user in the as-used position, taking a rotor thickness measurement.

Brake drum interior measuring jaws 14 which are employed for measuring a brake drum diameter between opposing walls, as depicted in FIG. 2, will point the opposite direction of the exterior measurement jaws 12 when the device 10 is in the as-used position with the user taking a measurement of the interior diameter of a brake drum 13.

The digital display 16 is visible directly to the eyes of the user in the as-used position whether the rotor (not shown) is perpendicular to a surface upon which it rests or is in the jaws of a vice. The digital display 16 is also visible directly to the user during a measurement of a drum 13.

The digital display 16 provides a calibrated means for axially adjusting either the distance of the exterior measurement jaws 12 or interior measurement jaws 14 from each other and indicating the extent of movement or distance thereof or therebetween from a normal “zero” position which can be set by pressing the zeroing button 23. Indica on the digital display 16 is always right-side-up to the user during all measurements taken in the as-used position.

One unique construction aspect of the device 10 allows the drum 13 to be supported on a surface such as a table or floor during this procedure with the opposing sidewall edges 15 of the drum 13 extending away from the support surface. Both the exterior measurement jaws 12 and interior measurement jaws 14 have at least one jaw translatably engaged to an elongated member 27 with each translatably engaged jaw in operative engagement with a digital display 16 which has a zero button 23 to zero out the reading and which will measure the position of each translatable jaw relative to the stationary one of each pair to take and display the measurement of the distance and therefor the thickness of the sidewall 17 or rotor surface (not shown).

During use in the as-used position in the hands of a user who is biasing the interior measuring jaws 14 against the sidewall 17 interior surface, with the jaws 14 extending downward, the digital display 16 is easily readable right-side-up by the user, just as in use for measuring the rotor with the exterior measuring jaws. Thus, in the as-used position, the digital display 16 is viewable without strain or contortions of the neck or body, while taking the measurements required as is the case with prior art.

Especially important is the further utility and ease of use which is provided by the wide shoulder portions 18 on each of the interior measuring jaws 14 combined with short pointed distal extensions 21 and notches 24 between the shoulder portions 18 and the distal extensions 21. The notches 24 are provided by the “L” shape of the jaws 14 where the shoulder portion 18 has an edge 25 substantially parallel to the axis 29 of the elongated member 27 engaging all the components of the device 10. Both edges 25 of both shoulder portions 18 are substantially the same distance from the axis 29 thereby positioning the device 10 level when supported on the opposing sidewall edges 15 with the heavy drum supported on a surface such as a table or the floor of a garage.

The shoulder potions 18 thus provide a resting surface for the device 10 which allows the user to rest the device 10 upon the shoulder portions 18 supported by the edges 15 of the sidewall 17 in the as-used position taking a measurement. Because of the extra wide shoulder portions 18, the device 10 will adapt to just about any configuration of drum 13 some of which can have edges 15 which are extended far from the sidewall 17 and inner surfaces being measured for the diameter of the drum 13.

In a particularly preferred mode of the device 10 both interior measuring jaws 14 would be translatably engageable on the member with one being fixedly engaged thereto by the user. This can be done with set screw knobs 11, or ratchet, or other conventional means to lock the one measuring jaw 14 in position along the member 27. For large heavy drums 13, this movement of the fixed jaw 14 will allow the user to a dust the member 27 left or right on the drum 13 to balance the device 10 thereon to alleviate tipping during use. Combined with the wide shoulder portions 18 it renders the device especially easy to use.

Extensions 19 extend a distance away from a first end of each shoulder portion 18 at an angle substantially perpendicular to the axis 29. Distal portions having pointed ends 30 extend substantially normal to the extensions 19 and parallel to the axis 29 toward the second end of the shoulder portion 18 forming the “L” shape. The length of the extensions 19 between the edges 25 and the distal extensions 21 define the notches 24 size. An inside wall 31 of each notch 24 angles away from the second end of the shoulder portion 18 which is especially preferred thereby providing an angled surface to the notch 24 to allow it to engage over odd type 15 edges on sidewall 17 which those skilled in the art know can take on widely differing configurations depending on use and manufacturer.

The shoulder portions 18 supported upon both edges of a drum, also provide a means to level the device 10 and a means to insert the pointed ends 30 of the interior jaws 14 to an equal distance from the edges 15 on which the shoulder portions 18 rest. This insures much more accurate measurements than conventional devices where the user must try and balance the drum 13 while concurrently biasing the jaws 14 and concurrently looking for the digital read out. In such devices the user tends to angle the member 27 while attempting the measurement which tends to lead to inaccurate measurements. Further, employing the shoulders 18 to position the tips 30 at substantially the same position in the drum spaced from the edges 15 in the as-used position, thereby provides increased accuracy with a true and level reading across the diameter of the drum and at a constant depth from the edge 15 at both measurement points on the sidewall 17 contacted by the tips 30. Conventional devices lacking the large shoulders 18 and pointed tips 30 can easily misread a diameter measurement by mis-positioning to an angled engagement of the member 27 where the tips 30 measure different positions on the drum sidewall 17 and receive an inaccurate measurement.

As noted, and particularly preferred, to provide for the most accommodation of brake drums 13 and achieve the mount of the shoulder portions 18 on the sidewalls 17 it has been found that shoulder portions 18 from first end to second end which are substantially twice the length of the distal portions 21 from edge to tip 30, works well in providing a very stable, level positioning of the device 10 on the widest variety of diameter drums 13 from larger truck drums 13 having extremely thick sidewalls 17, to small car drums 13, or worn drums 13 having much thinner sidewalls 17. The large shoulders 18 as mentioned concurrently provide constant equalization of positioning of the tips 30 into the drum 13 on both sidewalls 17 maximizing accuracy of diameter measurements on all types of drums. Additionally, if desired, where the safe diameter measurement of the interior of the sidewalls 17 is not known for turning purposes, such as with non OEM drums 13, the actual thickness can be determined by employing the exterior jaws 12 to measure the exterior of the sidewall 17 and subtracting the diameter measurement of the interior of the sidewalls 17. Again, in the as-used position, the numerals of the digital display 16 will be upright and easy to read in such a measurement making the device 10 easy to read, with numerals right-side-up and in plain view in all measurement taken with the device 10.

While all of the fundamental characteristics and features of the electronic disc and drum brake gauge have been disclosed and described, with reference to particular embodiments thereof, a latitude of modification, various changes and substitutions are intended in the foregoing disclosure and it will be apparent that in some instance, some features of the invention will be employed without a corresponding use of other features without departing from the scope of the invention as set forth. It should be understood that such substitutions, modifications, and variations may be made by those skilled in the art without departing from the spirit or scope of the invention. Consequently, all such modifications and variations are included within the scope of the invention as defined herein.

What is claimed is:

1. A brake disc and drum measuring apparatus, comprising:
an elongated member having a center axis therethrough;
a first pair of jaws for measuring thickness of a rotor;
a first of said first pair of jaws engaged to said member;
a second of said first pair of jaws, translatably engaged to said member;
a second pair of jaws for measuring diameter across the inside of a brake drum;
a first of said second pair of jaws, fixedly engageable to said elongated member;
a second of said second pair of jaws, engaged to said member;
a calibrated means for axially adjusting said second jaw from said first jaw of said first pair of jaws, and said second jaw from said first jaw in said second pair of jaws, and indicating the extent of distance thereof from a normal or “zero” position;
said calibrated means having an electronic display of indica representative of said distance;
said apparatus having an in-use position during employment by a user for measuring either a said drum or said disc;
said first pair of jaws extending generally upward in said as-used position;
said second pair of jaws extending opposite said first pair of jaws; and
said indica being right-side-up during a measuring of any said distance with either said first pair of jaws or said second pair of jaws.

2. The brake disc and drum measuring apparatus of claim 1 additonally comprising:
each of said second pair of jaws having a shoulder portion connected to a distal end by an extension;
each said distal end having a tip portion;
said should portion and said distal end extending substantially parallel to said axis of said member;
said extension extending substantially normal to said axis and defining a gap between said shoulder portion and said distal end;
each said shoulder portion having a width longer than a length of each said distal end;
each said shoulder portion having an edge surface substantially equidistant from said center axis;
said shoulder portion providing a means to support said apparatus, in said in-use position, upon the distal edge of a sidewall of a said brake drum; and
said width of said shoulder portions providing means to accommodate odd shaped and elongated types of said distal edges of a said brake drum which extend a distance beyond a diameter of said brake drum between said side wall, while maintaining said tip portions of both said distal ends at a position substantially equidistant with each other along an inside surface of said sidewall to be measured.

3. The brake disc and drum measuring apparatus of claim 2 additonally comprising:
said width of said shoulder portions being at least twice as long as said length of said distal ends.

4. The brake disc and drum measuring apparatus of claim 2 additonally comprising:
said extension having an edge wall, said edge wall defining an angled surface of said gap; and
said angled surface providing means to accommodate extensions from said sidewall.

5. The brake disc and drum measuring apparatus of claim 3 additonally comprising:
said extension having an edge wall, said edge wall defining an angled surface of said gap; and
said angled surface providing means to accommodate extensions from said sidewall.

6. The brake disc and drum measuring apparatus of claim 1 additonally comprising:
said second of said second pair of jaws being translatably engaged to said member;
said second of said second pair of jaws axially translatably along said member to any position between the opposite ends of said member;
means to engage said second of said second pair of jaws to a fixed position on said member; and
translation of said second of said second pair of jaws to said fixed position providing means to balance said measuring apparatus with said shoulder portions resting upon said distal edges of said sidewall of said drum.

7. The brake disc and drum measuring apparatus of claim 2 additonally comprising:
said second of said second pair of jaws being translatably engaged to said member;
said second of said second pair of jaws axially translatably along said member to any position-between the opposite ends of said member;
means to engage said second of said second pair of jaws to a fixed position on said member; and
translation of said second of said second pair of jaws to said fixed position providing means to balance said measuring apparatus with said shoulder portions resting upon said distal edges of said sidewall of said drum.

8. The brake disc and drum measuring apparatus of claim 3 additonally comprising:
said second of said second pair of jaws being translatably engaged to said member;
said second of said second pair of jaws axially translatably along said member to any position between the opposite ends of said member;
means to engage said second of said second pair of jaws to a fixed position on said member; and
translation of said second of said second pair of jaws to said fixed position providing means to balance said measuring apparatus with said shoulder portions resting upon said distal edges of said sidewall of said drum.

9. The brake disc and drum measuring apparatus of claim 4 additonally comprising:
said second of said second pair of jaws being translatably engaged to said member;
said second of said second pair of jaws axially translatably along said member to any position between the opposite ends of said member;
means to engage said second of said second pair of jaws to a fixed position on said member; and
translation of said second of said second pair of jaws to said fixed position providing means to balance said measuring apparatus with said shoulder portions resting upon said distal edges of said sidewall of said drum.

10. The brake disc and drum measuring apparatus of claim 5 additonally comprising:
said second of said second pair of jaws being translatably engaged to said member;
said second of said second pair of jaws axially translatably along said member to any position between the opposite ends of said member;
means to engage said second of said second pair of jaws to a fixed position on said member; and
translation of said second of said second pair of jaws to said fixed position providing means to balance said measuring apparatus with said shoulder portions resting upon said distal edges of said sidewall of said drum.
